(19) United States
(12) Patent Application Publication
(10) Pub. No.: US 2011/0063837 A1
(43) Pub. Date: Mar. 17, 2011

(54) LED ARRAY MODULE AND LED ARRAY MODULE FRAME

(75) Inventors: Alexander RIZKIN, Livermore, CA (US); Robert Tudhope, Livermore, CA (US); Keith Scott, Livermore, CA (US); Vahid S. Moshtagh, Livermore, CA (US)

(73) Assignee: Bridgelux, Inc., Livermore, CA (US)

(21) Appl. No.: 12/883,978

(22) Filed: Sep. 16, 2010

Related U.S. Application Data
(60) Provisional application No. 61/242,880, filed on Sep. 16, 2009.

(51) Int. Cl. F21V 7/00; F21S 4/00

(52) U.S. Cl. 362/235; 362/249.02

(57) ABSTRACT

A solid state light emitter module frame includes a supporting member, legs, and arms. The supporting member is configured to support a reflector. The legs are coupled to the supporting member. The arms are coupled to the supporting member and extend inwardly towards an inner edge of the supporting member. Each of the arms has an attachment mechanism for attaching to an solid state light emitter array.

### CROSS-REFERENCE TO RELATED APPLICATION(S)

This Application claims the benefit of U.S. Provisional Patent Application No. 61/242,880, entitled “LED Array Module and LED Array Module Frame,” filed on Sep. 16, 2009, which is expressly incorporated by reference herein in its entirety.

### BACKGROUND

1. Field

The present disclosure relates to a light emitting diode (LED) array module and, more particularly, to aspects of the LED array module and to a frame of the LED array module.

2. Description of Related Art

LEDs have been developed for many years and have been widely used in various light applications. As LEDs are light-weight, consume less energy, and have a good electrical power to light conversion efficacy, they have been used to replace conventional light sources, such as incandescent lamps and fluorescent light sources. LEDs may be utilized in an array module.

### SUMMARY

In one aspect of the disclosure, an LED module frame includes a supporting member, legs, and arms. The supporting member is configured to support a reflector. The legs are coupled to the supporting member. The arms are coupled to the supporting member and extend inwardly towards an inner edge of the supporting member. Each of the arms has an attachment mechanism for attaching to an LED array.

### BRIEF DESCRIPTION OF THE DRAWINGS

FIGS. 1A-1C are views of an exemplary LED array module.

FIGS. 2A-2D are views of an exemplary frame of the LED array module.

FIGS. 3A-3C are views of additional exemplary frames.

FIG. 4 is a view of an exemplary LED module.

FIG. 5 is a view of another exemplary frame.

FIGS. 6A-6D are top views of heat sinks to which the exemplary LED modules may attach.

FIG. 7 is a view of an exemplary array of LED modules.

### DETAILED DESCRIPTION

Various aspects of the present invention will be described herein with reference to drawings that are schematic illustrations of idealized configurations of the present invention. As such, variations from the shapes of the illustrations as a result, for example, manufacturing techniques and/or tolerances, are to be expected. Thus, the various aspects of the present invention presented throughout this disclosure should not be construed as limited to the particular shapes of elements (e.g., regions, layers, sections, substrates, etc.) illustrated and described herein but are to include deviations in shapes that result, for example, from manufacturing. By way of example, an element illustrated or described as a rectangle may have rounded or curved features and/or a gradient concentration at its edges rather than a discrete change from one element to another. Thus, the elements illustrated in the drawings are schematic in nature and their shapes are not intended to illustrate the precise shape of an element and are not intended to limit the scope of the present invention.

It will be understood that when an element such as a region, layer, section, substrate, or the like, is referred to as being “on” another element, it can be directly on the other element or intervening elements may also be present. In contrast, when an element is referred to as being “directly on” another element, there are no intervening elements present. It will be further understood that when an element is referred to as being “formed” on another element, it can be grown, deposited, etched, attached, connected, coupled, or otherwise prepared or fabricated on the other element or an intervening element. In addition, when a first element is “coupled” to a second element, the first element may be directly connected to the second element or the first element may be indirectly connected to the second element with intervening elements between the first and second elements.

Furthermore, relative terms, such as “lower” or “bottom” and “upper” or “top,” may be used herein to describe one element's relationship to another element as illustrated in the drawings. It will be understood that relative terms are intended to encompass different orientations of an apparatus in addition to the orientation depicted in the drawings. By way of example, if an apparatus in the drawings is turned over, elements described as being on the “lower” side of other elements would then be oriented on the “upper” side of the other elements. The term “lower” can therefore encompass both an orientation of “lower” and “upper,” depending of the particular orientation of the apparatus. Similarly, if an apparatus in the drawing is turned over, elements described as “below” or “beneath” other elements would then be oriented “above” the other elements. The terms “below” or “beneath” can therefore encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and this disclosure.

As used herein, the singular forms “a,” “an,” and “the” are intended to include the plural forms as well, unless the context clearly indicates otherwise. It will be further understood that the terms “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. The term “and/or” includes any and all combinations of one or more of the associated listed items.

Various aspects of an LED array module may be illustrated with reference to one or more exemplary configurations. As used herein, the term “exemplary” means “serving as an example, instance, or illustration,” and should not necessarily be construed as preferred or advantageous over other configurations of an LED array module disclosed herein. Additionally, LEDs are but one form of solid state light emitters. Thus, the exemplary configurations, described with reference to LEDs, are representative of any solid state light emitter which may be used in embodiments of the disclosure.

Furthermore, various descriptive terms used herein, such as “on” and “transparent,” should be given the broadest meaning possible within the context of the present disclosure. For example, when a layer is said to be “on” another layer, it should be understood that that one layer may be deposited, etched, attached, or otherwise prepared or fabricated directly or indirectly above or below that other layer. In addition, something that is described as being “transparent” should be understood as having a property allowing no significant obstruction or absorption of electromagnetic radiation in the particular wavelength (or wavelengths) of interest, unless a particular transmittance is provided.

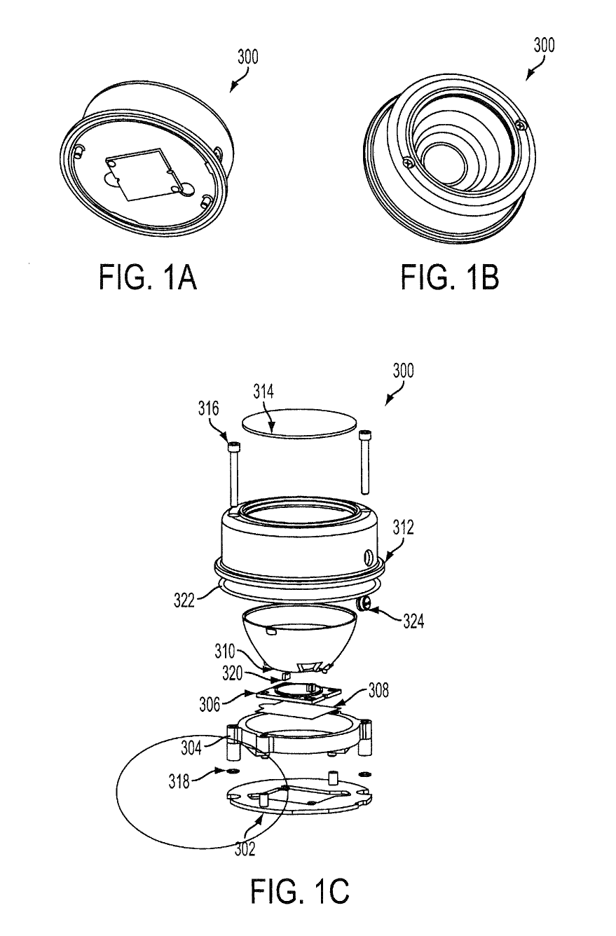

FIG. 1A and FIG. 1B are perspective views of an exemplary LED array module 300. FIG. 1C is a perspective exploded view of the LED array module 300. As shown in FIG. 1C, the LED array module 300 includes a printed circuit board 302, a frame 304 attachable to the printed circuit board 302, an LED array 306 attachable to the frame 304, a removable thermal grease sheet 308 that is attached to a bottom surface of the LED array 306 and is removed prior to attaching the module 300 to a heat sink, a reflector 310 for transforming light from the LED array 306, a cover 312 for covering the LED array 306 and the reflector 310, and a secondary optic 314 for further transforming the light emitted from the LED array 306.

Bolts 316 insert through the cover 312, through the frame 304, and through cutouts on the printed circuit board 302 for allowing the module 300 to attach to a heat sink. A Teflon nut 318 inserted into leg of frame 304 threads onto screw 316 holding cover 312, reflector 310, and frame 304 together as a subassembly. An electrical connector 320 may be coupled to the LED array 306. The LED array 306, reflector 310 and printed circuit board 302 are sealed within the cover 312 with the silicone o-ring 322 and a rubber grommet 324 that is insertable into a hole in the side of the cover 312.

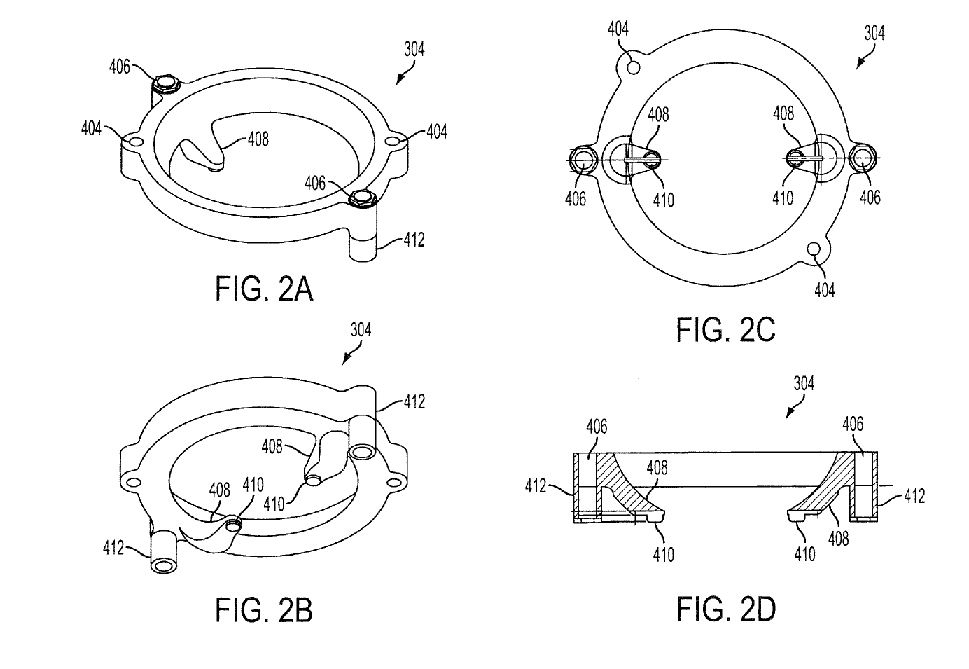

FIGS. 2A-2D are views of the frame 304. The frame 304 is circular and has holes 404 for attaching to the printed circuit board 302. The frame 304 further includes legs 412 with holes 406 for allowing the cover 312 to attach to the frame 304 and for allowing both the cover 312 and the frame 304 to attach to a heat sink with the bolts 316. The frame includes arms 408 that extend inwardly from the circular edge of the frame 304. The arms 408 have compression feet 410 for attaching to respective holes in the LED array 306. The length of the legs 412 and the height of the arms 408 are configured such that the attached LED array 306 extends slightly below the legs 412. Such a configuration allows the attached LED array 306 to make full contact with a heat sink without being limited in movement by the legs 412.

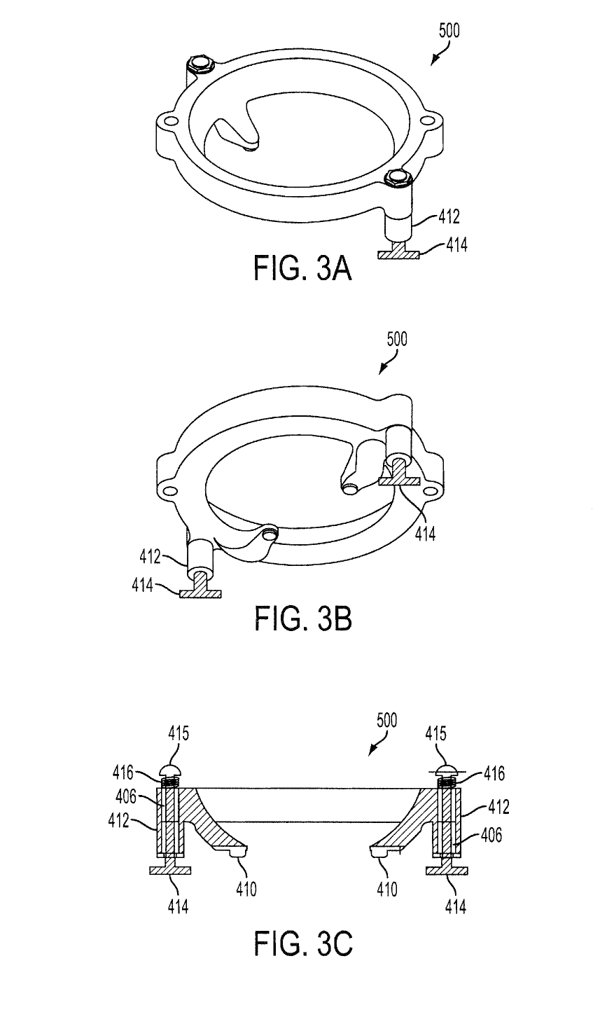

FIGS. 3A-3C are views of an exemplary frame 500. The frame 500 includes pins 414 that extend from the legs 412. The pins 414 extend from the bottom of the legs 412 and are configured to be inserted into slots within a heat sink so that the LED array module 300 may be locked to the heat sink without the use of the bolts 316. In such a configuration, the bolts 316 may be replaced with screws and screw holes may be provided within the frame 500 for connecting the cover 312 to the frame 500. As shown in FIG. 3C, in another configuration, the pins 414 may have a pressable head 415 that is biased upward by a compression spring 416. In such a configuration, a user may press the heads 415 of the pins 414 while inserting and securing the pins 414 within respective slots of the heat sink. Once the pins are secured within the heat sink, the user may depress the heads 415 of the pins 414. The compression springs 416 exert an upward force on the pins 414, thus allowing the pins 414 to be locked within the slots of the heat sink. In such a configuration, the slots of the heat sink are configured such that once the pins 414 are rotated, the pins 414 are allowed to move upwardly within the slots.

Alternatively, tension springs may be used within the holes 406 of the legs 412 in order to apply an upward force on the pins 414. The pins 414 may be configured to be stationary with respect to the frame 500. In such a configuration, the user must press the heads 415 while rotating the frame 500 into a secured position with respect to the heat sink. Alternatively, the pins 414 may be configured to rotate with respect to the frame 500. In such a configuration, the heads 415 may include grooves to allow a screwdriver to press and to rotate the pins 414 into a secured position within the heat sink.

Because the frame 500 is fully enclosed within the cover 312, the pins 414 may be of such a length that the heads 415 of the pins 414 are exposed above the cover 312. In order to maintain the seal that the cover 312 provides, the cover 312 may include a flexible, but water resistant membrane, below which rest the heads 415 of the pins 414. In such a configuration, a user may press the membrane in order to press the heads 415 of the pins 414 in order to exert a force opposite to the force exerted by the springs.

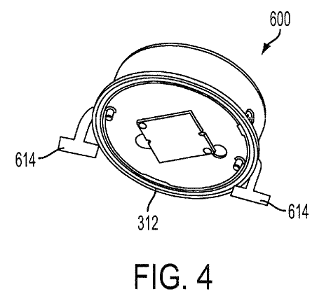

FIG. 4 is a view of an exemplary LED array module 600. The LED array module 600 includes pins 614 extending from a bottom surface. The pins 614 may be inserted into respective slots of a heat sink and may be secured to the heat sink by rotating the LED array module 600. As shown in FIG. 4, the pins 614 may extend from the cover 312.

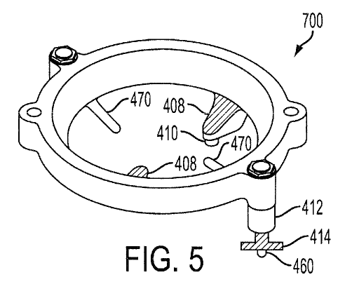

FIG. 5 is a view of another exemplary frame 700. The pins 414 may be further configured to provide an electrical power connection. In one configuration, the pins 414 each have a hole through which an insulated conductor 460 extends. In one configuration, the conductors 460 are rods. Each insulated conductor 460 is coupled to a respective conductor 470 (which may also be a rod), which extends inwardly from the frame 700 close to or in contact with a respective pad of an attached LED array 306. In such a configuration, the arms 408 may be offset from the legs 412 by approximately 90 degrees. The conductors 460, 470 may be copper or another conductor. The conductors 470 may be configured to touch or to be sufficiently close to corresponding pads of an attached LED array 306. Once the LED array 306 is attached, solder may be used to join the metal surfaces of the pads and the conductors 470. In such a configuration, wires would not need to be bonded to the pads of the LED array 306. In an alternative configuration, wires may be used instead of the conductors 470. In such a configuration, the wires would be coupled to the conductors 460.

As shown in FIG. 5, the frame 700 is configured to provide two functions: (1) a securing connection for securing the frame 700 to a heat sink or a lamp holder of any kind and (2) an automatic electrical connection once the frame 700 is secured to the heat sink. For example, this lamp holder may be similar to a twist-and-lock configuration, or bi-pin (BA). In such a configuration, replacement of an LED module 600 to a heat sink would be facilitated, as a user would not have to tighten any bolts or individually connect any power leads of the LED module. In order to prevent heat from the heat sink from affecting the conductivity of the conductors 460, the heat sink may have an insulated member to which the pins 414 attach.

The frame 700 would eliminate the need for the grommet 324 (which includes holes for the electrical wiring), thus improving the seal of the cover 312 in a harsh environment. While frame 700 shows the conductors 460 extending through the legs 412 within the pins 414, the conductors 460 may extend from another part of the frame 700 and be separate from the pins 414. In such a configuration, the insulated member of the heat sink would include slots for both the pins 414 and the conductors 460. The printed circuit board 302 includes holes through which both the pins 414 and the conductors 460 may extend.

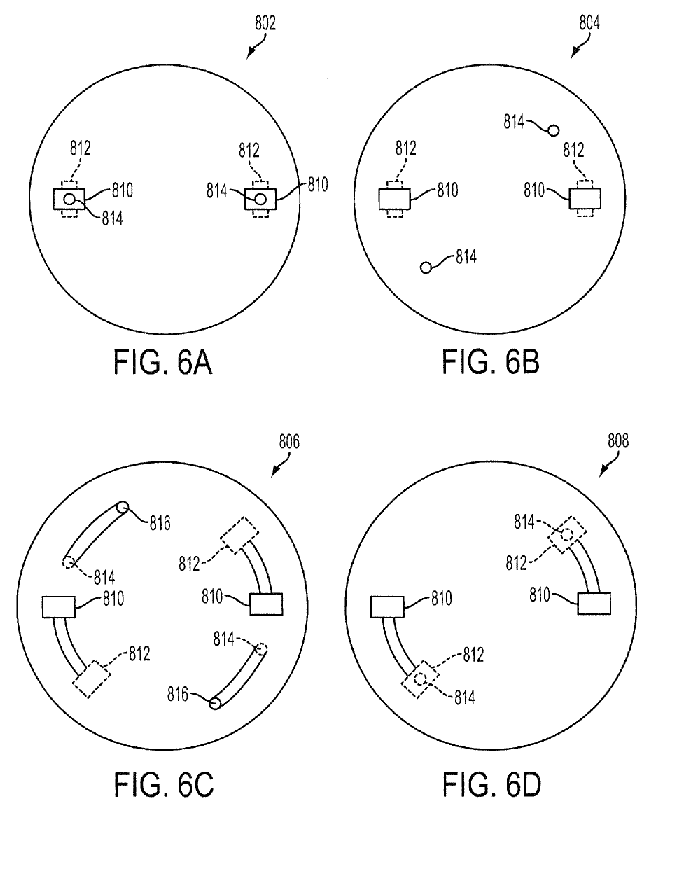

FIGS. 6A-6D are top views of heat sinks or lamp holders to which the LED array module 600 with the exemplary frame 700 may attach. As shown in FIG. 6A, a heat sink 802 is configured to accept an LED array module 700 with rotatable pins 414 with an inner conductor 460 (see FIG. 5). The pins 414 are inserted into slots 810 and are rotated into a locked position within corresponding inner slot 812. The conductors 460 contact power leads 814 within the inner slots 812. As shown in FIG. 6B, a heat sink or lamp holder 804 is configured to accept an LED array module with rotatable pins 414 and separate conductor rods 460. The pins 414 are inserted into the slots 810 and are rotated into a locked position within the inner slot 812. The separate conductor rods contact the power leads 814. As shown in FIG. 6C, a heat sink or lamp holder 806 is configured to accept an LED array module 700 with fixed pins 414 and separate conductor rods. The pins 414 are inserted into the slots 810 and the LED array module 700 is rotated in order to position the pins 414 into a locked position within the inner slots 812. The separate conductor rods are inserted into holes 816 and contact the power leads 814 after the LED array module 700 is fully rotated. As shown in FIG. 6D, a heat sink or lamp holder 808 is configured to accept an LED array module 700 with fixed pins 414 with an inner conductor 460. The pins 414 are inserted into the slots 810 and the LED module is rotated in order to position the pins 414 into a locked position within the inner slots 812. The conductors 460 contact the power leads 814 after the LED module is fully rotated.

As discussed supra, the heat sink may have an insulated member to which the LED module pins 414 attach. As such, the sections of the heat sinks 802-808 shown with pin slots and power leads may be the insulated member.

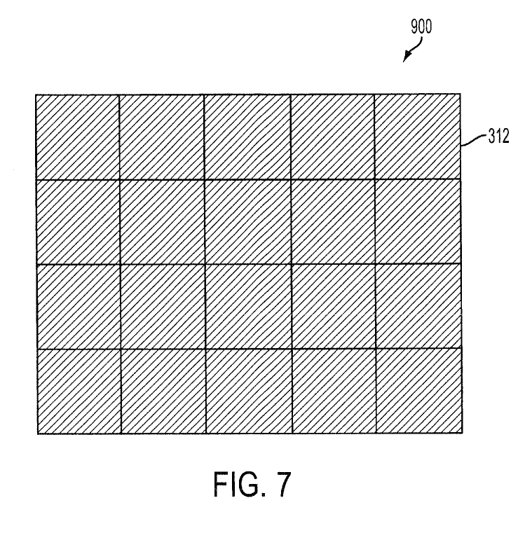

FIG. 7 is a view of an array of LED array modules 900. While the cover 312 is shown infra as circular, the cover 312 may alternatively be rectangular, hexagonal, or another suitable shape and may be configured to attach to one another, such as in a honeycomb fashion, to form the array of LED modules 900. The connection between each of the covers 312 may be a sliding connector, a physical connector such as a screw, or a snapping mechanism similar to standard electrical connectors, but on a larger scale.

The various aspects of this disclosure are provided to enable one of ordinary skill in the art to practice the present invention. Modifications to various aspects of an LED array module presented throughout this disclosure will be readily apparent to those skilled in the art, and the concepts disclosed herein may be extended to other applications. Thus, the claims are not intended to be limited to the various aspects of an LED array module presented throughout this disclosure, but are to be accorded the full scope consistent with the language of the claims. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A frame, comprising:
a supporting member;
one or more legs coupled to the supporting member; and
one or more arms extending inwardly from the supporting member, wherein the one or more arms are configured to support a plurality of solid state light emitters.

2. The frame of claim 1 wherein the supporting member further comprises one or more holes for attaching the frame to a printed circuit board, the printed circuit board supporting the solid state light emitters.

3. The frame of claim 1 wherein each of the one or more legs includes a hole for attaching a cover to the frame via a bolt.

4. The frame of claim 1 wherein each of the one or more legs includes a hole for attaching a cover and the frame to a heat sink via a bolt.

5. The frame of claim 1 wherein each of the one or more arms has a distal end with means for attaching the frame to a substrate supporting the solid state light emitters.

6. The frame of claim 5 wherein the means for attaching the frame to the substrate for each of the one or more arms comprises a compression foot.

7. The frame of claim 1 wherein the one or more legs have a height and are arranged with the one or more arms such that the solid state light emitters are supported in the frame below the legs.

8. The frame of claim 1 wherein each of the one or more legs includes a pin extending from a distal end thereof for attaching to a heat sink.

9. The frame of claim 8 wherein each of the one or more legs includes means for biasing the pin towards the distal end of the leg.

10. The frame of claim 9 wherein the means for biasing the pin for each of the one or more legs comprises a compression spring.

11. The frame of claim 9 wherein the means for biasing the pin for each of the one or more legs comprises a tension spring.

12. The frame of claim 8 wherein the pin for each of the one or more legs includes means for providing an electrical power connection to the solid state light emitters.

13. The frame of claim 12 wherein the means for providing an electrical power connection to the solid state light emitters in the pin for each of the one or more legs comprises a hole in the pin for routing an electrical conductor to the solid state light emitters.

14. A solid state light emitter module, comprising:
a printed circuit board;
a frame coupled to the printed circuit board; and
a solid state light emitter coupled to the frame.

15. The solid state light emitter module of claim 14, comprising a reflector coupled to the frame.

16. The solid state light emitter module of claim 14, comprising a cover coupled at a first end to the frame for covering the LED array.

17. The solid state light emitter module of claim 14, comprising a secondary optic coupled at a second end of the cover opposite to the first end.

18. The solid state light emitter module of claim 14, the frame comprising:
a supporting member;
one or more legs having a proximal end coupled to the supporting member; and
one or more arms extending inwardly from the supporting member, wherein the one or more arms are configured to support a plurality of solid state light emitters.

19. The solid state light emitter module of claim 14 wherein the supporting member further comprises one or more holes for attaching the frame to a printed circuit board, the printed circuit board supporting the solid state light emitters.

20. The solid state light emitter module of claim 14 wherein each of the one or more legs includes a hole for attaching a cover to the frame via a bolt.

21. The solid state light emitter module of claim 14 wherein each of the one or more legs includes a hole for attaching a cover and the frame to a heat sink via a bolt.

22. The solid state light emitter module of claim 14 wherein each of the one or more arms has a distal end with means for attaching the frame to a substrate supporting the solid state light emitters.

23. The solid state light emitter module of claim 22 wherein the means for attaching the frame to the substrate for each of the one or more arms comprises a compression foot.

24. The solid state light emitter module of claim 14 wherein the one or more legs have a height and are arranged with the one or more arms such that the solid state light emitters are supported in the frame below the legs.

25. The solid state light emitter module of claim 14 wherein each of the one or more legs includes a pin extending from a distal end thereof for attaching to a heat sink.

26. The solid state light emitter module of claim 25 wherein each of the one or more legs includes means for biasing the pin towards the distal end of the leg.

27. The solid state light emitter module of claim 26 wherein the means for biasing the pin for each of the one or more legs comprises a compression spring.

28. The solid state light emitter module of claim 26 wherein the means for biasing the pin for each of the one or more legs comprises a tension spring.

29. The solid state light emitter module of claim 25 wherein the pin for each of the one or more legs includes means for providing an electrical power connection to the solid state light emitters.

30. The solid state light emitter module of claim 29 wherein the means for providing an electrical power connection to the solid state light emitters in the pin for each of the one or more legs comprises a hole in the pin for routing an electrical conductor to the solid state light emitters.

31. The solid state light emitter module of claim 25, further comprising a removable thermal grease sheet attachable to a bottom surface of the solid state light emitters and removable prior to attaching the solid state light emitter module to the heat sink.

32. A frame, comprising:
a supporting member;
one or more arms extending inwardly from the supporting member; and
one or more legs coupled to the supporting member wherein the one or more legs are configured to support a plurality of solid state light emitters.

33. The frame of claim 32 wherein the supporting member further comprises one or more holes for attaching the frame to a printed circuit board, the printed circuit board supporting the solid state light emitters.

34. The frame of claim 32 wherein each of the one or more legs includes a hole for attaching a cover to the frame via a bolt.

35. The frame of claim 32 wherein each of the one or more legs includes a hole for attaching a cover and the frame to a heat sink via a bolt.

36. The frame of claim 32 wherein each of the one or more arms has a distal end with means for attaching the frame to a substrate supporting the solid state light emitters.

37. The frame of claim 36 wherein the means for attaching the frame to the substrate for each of the one or more arms comprises a compression foot.

38. The frame of claim 32 wherein the one or more legs have a height and are arranged with the one or more arms such that the solid state light emitters are supported in the frame below the legs.

39. The frame of claim 32 wherein each of the one or more legs includes a pin extending from a distal end thereof for attaching to a heat sink.

40. The frame of claim 39 wherein each of the one or more legs includes means for biasing the pin towards the distal end of the leg.

41. The frame of claim 40 wherein the means for biasing the pin for each of the one or more legs comprises a compression spring.

42. The frame of claim 40 wherein the means for biasing the pin for each of the one or more legs comprises a tension spring.

43. The frame of claim 39 wherein the pin for each of the one or more legs includes means for providing an electrical power connection to the solid state light emitters.

44. The frame of claim 43 wherein the means for providing an electrical power connection to the solid state light emitters in the pin for each of the one or more legs comprises a hole in the pin for routing an electrical conductor to the solid state light emitters.
